(19) United States
(12) Patent Application Publication
(10) Pub. No.: US 2008/0158607 A1
(43) Pub. Date: Jul. 3, 2008

(54) Image processing apparatus

(75) Inventors: Nobuyuki Ueda, Nara (JP); Shuhji Fujii, Kyoto (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 11/999,898

(22) Filed: Dec. 7, 2007

(30) Foreign Application Priority Data
Dec. 7, 2006 (JP) 2006-330088

(51) Int. Cl. H04N 1/40

(52) U.S. Cl. 358/2.1; 358/462

(57) ABSTRACT

Even if similar images which are similar to specific images exist in image data, the influence of the similar images is eliminated so that restriction of processing can be executed without fail. There are provided a detection section 70 for detecting specific images and similar images in a form similar to the form of the specific images in the image data, a judgment section 71 for judging whether or not the specific images are included in the image data on the basis of a threshold, an identification section 72 for identifying a target area in which the similar images exist, and a threshold determination section 73 for determining the threshold. The threshold determination section 73 determines the threshold on the basis of the size ratio of the target area to a predetermined range.

### BACKGROUND OF THE INVENTION

1. Field of the Invention

The present invention relates to an image processing apparatus for restricting processings such as copying, facsimile communication and data transmission, on the basis of specific images included in image data.

2. Description of the Related Art

In an image processing apparatus, processing for inputting image data and outputting the image data by copying, facsimile communication or data communication is executed. When specific images are included in the image data, the processing to be executed is restricted. For example, the processing is inhibited. Thereby, unauthorized use of the inputted image data can be prevented.

Generally, a document is formed so that multiple specific images are included in image data corresponding to one page. From image data inputted by reading this document, specific images are detected. In this case, the number of specific images is counted in order to certainly judge that the specific images are included. When the number of specific images exceeds a threshold, it is judged that specific images exist, and restriction of processing is performed.

For example, in Japanese Patent Laid-Open No. 2001-94771, a threshold for identifying specific images for paper money, securities and the like is set for each kind of image data, such as copy data, facsimile data and printer data. When it is detected that specific images are included in inputted image data, printing of the image data is inhibited. In Japanese Patent Laid-Open No. 7-123254, when it is recognized that a specific image repeatedly appears in the image data of a document, the output state of an image to be outputted is changed.

Among inputted image data, there may exist an image in a form similar to the form of specific images. For example, the background of a document may resemble specific images. When specific images are detected, the detection is influenced by similar images. For example, there is a possibility that a specific image is hidden among similar images and is not detected. As a result, the number of detected specific images does not exceed a threshold, and restriction of processing is not performed though the processing should be restricted. On the contrary, if a similar image is misdetected as a specific image, processing is restricted though the restriction of the processing is not necessary, which is inconvenient for a user.

In view of the above situation, the object of the present invention is to provide an image processing apparatus capable of, when similar images which are similar to specific images exist in image data, executing restriction of processing without fail, by eliminating the influence of the similar images.

### SUMMARY OF THE INVENTION

The present invention is provided with a detection section for detecting specific images in image data, a judgment section for judging whether or not the specific images are included in the image data on the basis of a threshold, and an identification section for, when similar images in a form similar to the form of the specific images exist, identifying the similar images. The judgment section eliminates the influence of the identified similar images to make judgment.

When similar images exist in image data, detection of specific images is influenced thereby. By identifying the similar images by the identification section, existence of the similar images is clarified. Then, the judgment section avoids the similar images to make judgment or changes the threshold. Thereby, judgment of specific images can be prevented from being influenced by the similar images.

Specifically, a threshold determination section for determining the threshold is provided; the identification section identifies a target area in which the similar images exist; and the threshold determination section changes the threshold on the basis of the target area. There is a possibility that a similar image is regarded as a specific image in the target area. In consideration of the possibility, the threshold in the target area is changed so that it increases.

The judgment section judges whether the specific images are included in a predetermined range including the target area, on the basis of the changed threshold. Accordingly, even if similar images exist, the judgment can be performed without being influenced by the similar images.

Alternatively, the identification section identifies a target area in which the similar images exist, and the judgment section excludes the target area when performing judgment. When judgment is performed, judgment of specific images is performed in the predetermined range excluding the target area. That is, the similar images are ignored, and the influence of the similar images is eliminated.

When identifying the similar images, the detection section detects similar images within the predetermined range, and the identification section subdivides the predetermined range to identify the target area. By subdividing the predetermined range, the area in which the similar images exist is narrowed. Finally, the area in which the similar images exist is limited, and the area is set as the target area. In this way, by identifying the target area, the similar images are identified.

The identification section judges whether there is a similar image or not in each of areas obtained by subdividing the predetermined range, and exclude areas having no similar image to identify the target area. The areas having no similar image are non-target areas, and only the area in which a similar image exists is left, and thereby the target area is limited.

The detection section detects position information about similar images within a predetermined range, and the identification section identifies the target area on the basis of the position information. Since the positions where the similar images exist are clarified by the position information, the target area is limitedly identified.

The identification section identifies similar images existing on the outer edge, from the position information about the multiple similar images and demarcates the perimeter of the target area. By determining the perimeter so that it passes the multiple similar images on the outer edge, a surrounded area is formed. The other similar images exist inside this area, and the target area is identified in accordance with the distribution of the similar images.

When changing the threshold, the threshold determination section determines the threshold on the basis of the size ratio of the target area to the predetermined range. As for the non-target area also, a threshold is determined on the basis of the size ratio of the non-target area to the predetermined range.

According to the present invention, even if similar images exist in image data, it is possible to, when performing judgment of specific images, change the judgment criterion so that the judgment is not influenced by the similar images by identifying a target area in which the similar images exist. Thereby, it is possible to accurately make judgment of specific images and execute restriction of processing of image data including the specific images.

### BRIEF DESCRIPTION OF THE DRAWINGS

FIG. 1 is a control block diagram of the image processing apparatus of the present invention;

FIG. 2 is a diagram showing the schematic whole configuration of the image processing apparatus;

FIG. 3 is a diagram showing a document in which specific images are arranged and an enlarged specific image;

FIG. 4 is a diagram showing a document in which similar images exist;

FIG. 5 is a flowchart of judging specific images in image data in which similar images exist;

FIG. 6 is a flowchart of identifying a target area;

FIG. 7 is a diagram showing a page divided in two;

FIG. 8 is a diagram showing that an area in which similar images exist is divided in two;

FIG. 9 is a diagram showing that the area in which the similar images exist is fragmented;

FIG. 10 is a diagram showing that the area in which the similar images exist is re-divided;

FIG. 11 is a diagram showing an identified target area;

FIG. 12 is a flowchart of judging specific images in image data in which similar images exist;

FIG. 13 is a diagram showing display of the coordinates of similar images;

FIG. 14 is a diagram showing a target area identified on the basis of the coordinates;

FIG. 15 is a diagram showing a target area identified on the basis of the coordinates of another embodiment; and

FIG. 16 is a flowchart of judging specific images in image data in which similar images exist, in the case where a target area cannot be identified.

### DETAILED DESCRIPTION OF THE PREFERRED EMBODIMENTS

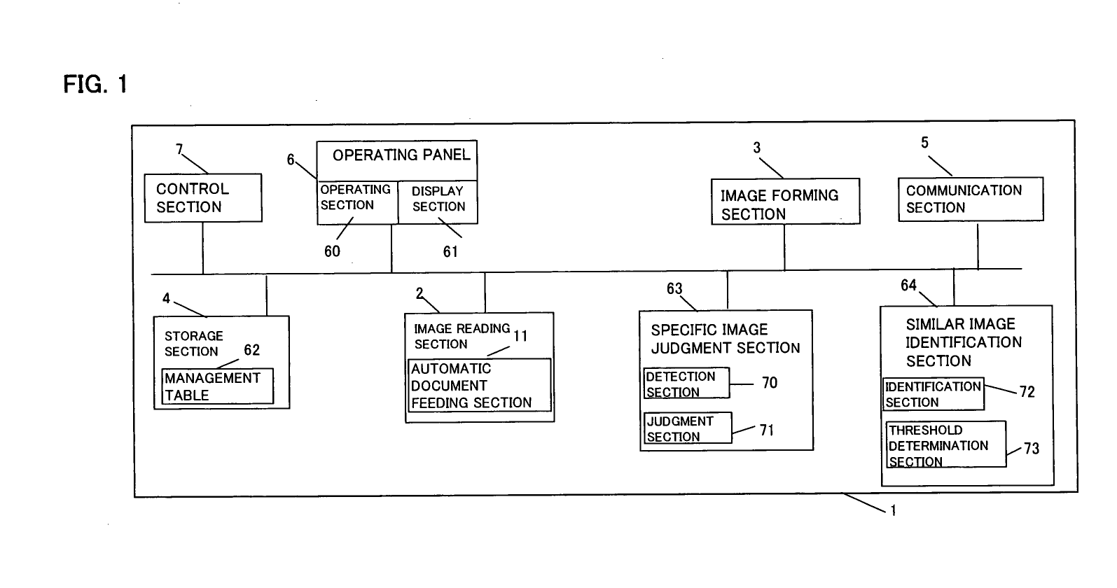

FIG. 1 shows the image processing apparatus of this embodiment. This image processing apparatus, which is a complex machine for executing a copy mode, a print mode, a scanner mode and a facsimile mode, includes in a cabinet 1 an image reading section 2 for reading a document and inputting image data, an image forming section 3 for processing and printing the image data, a storage section 4 for storing the image data, a communication section 5 for communicating with an external apparatus, an operation panel 6 for performing an input operation, and a control section 7 for controlling a processing section to execute processing of the image data in accordance with the mode. The rocessing section is for processing the inputted image data to output it, and it is assumed to be constituted by the image forming section 3, the storage section 4 and the communication section 5.

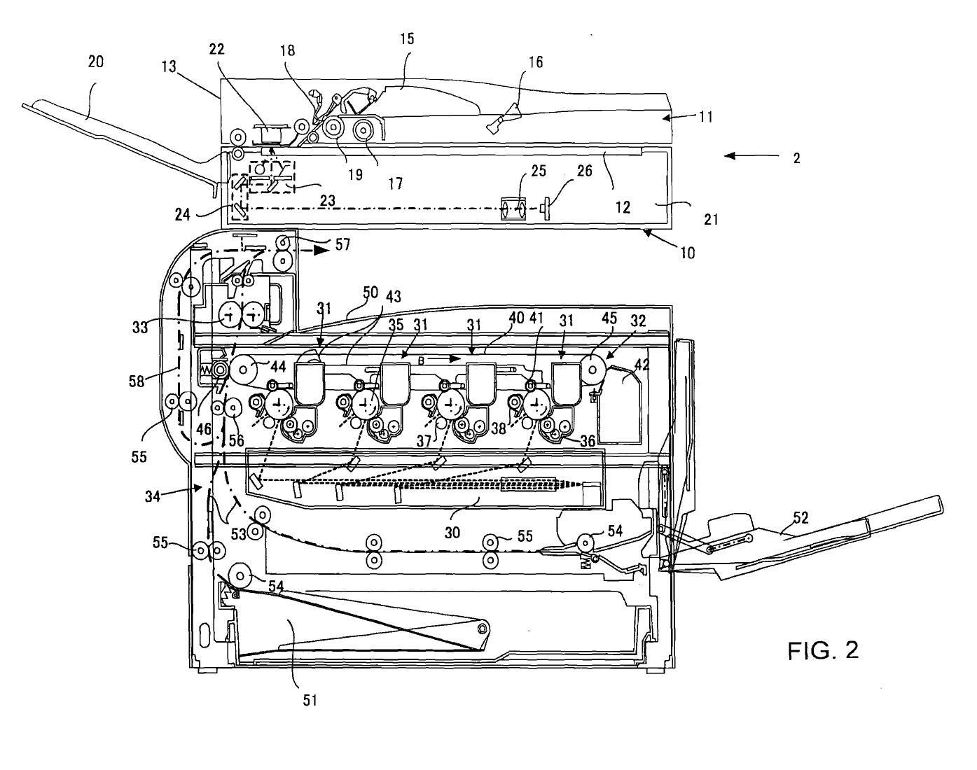

As shown in FIG. 2, the image reading section 2 is arranged above the cabinet 1, and it is provided with a scanner section 10 and an automatic document feeding section 11. The automatic document feeding section 11 is provided above the scanner section 10, and it automatically feeds a document to read the image data of the document.

A document table 12 made of platen glass is provided on the top surface of the cabinet 1, and a document cover 13 covering the document table 12 is provided. The automatic document feeding section 11 is integrally mounted on the document cover 13. The document cover 13 can be freely opened and closed, and a document is fed by the automatic document feeding section 11 when the document cover 13 is closed. When the document cover 13 is opened, a document can be placed on the document table 12. Opening and closing of the document cover 13 is detected by a cover opening/closing sensor. A document size detection sensor for detecting the size of a document placed on the document table 12 is also provided.

When documents are set in a document set tray 15 of the automatic document feeding section 11, a document detection sensor 16 detects that the documents are set. Then, on the operation panel 6, the sheet size to be printed and copy conditions such as a varied magnification are inputted. After that, reading of the image of the documents is started by an input operation of a start key.

On the automatic document feeding section 11, each document on the document set tray 15 is drawn out by a pickup roller 17 one by one. The document passes between a stacking plate 18 and a feeding roller 19, and is sent to the document table 12. The document is fed on the document table 12 in the vertical scanning direction and discharged to a document discharge tray 20. A document discharge sensor is provided for the document discharge tray 20 to detect whether or not there is a document on the document discharge tray 20.

The scanner section 10 is provided with a first reading section 21 and a second reading section 22. A reading area is formed on one side of the document table 12. When a document is fed on the document table 12, it passes through the reading area. Below the reading area, a first scanning unit 23 of the first reading section 21 is positioned to read the surface (downside surface) of the document.

When the document is carried to the document table 12 by the automatic document feeding section 11, the first scanning unit 23 is moved to and positioned at the reading position, and a second scanning unit 24 is also positioned at a predetermined position. The surface of the document is illuminated by the exposure lamp of the first scanning unit 23 from below the document table 12. A light reflected from the document is led to an image forming lens 25 by the reflecting mirrors of the first and second scanning units 23 and 24. The light reflected form the document is concentrated to a CCD 26 by the image forming lens 25. The image on the surface of the document is formed on the CCD 26. Thereby, the image on the surface of the carried document is read.

The back side (upside surface) of the document is read by the second reading section 22. The second reading section 22 is arranged above the document table 12, and it is provided with LEDs for illuminating the back side of the document, an exposure lamp array having fluorescent lamps, a SELFOC lens array for collecting, for each pixel, a light reflected from the document, a contact image sensor (CIS) for performing optical/electric conversion of the light reflected from the document, which has been received through the SELFOC lens array, to output an analog image signal, and the like. Thereby, the image on the back side of the fed document is read.

When a document is placed on the document table 12, the image on the surface of the document is read by the first reading section 21. The first and second scanning units 23 and 24 move in the vertical scanning direction, keeping a predetermined mutual speed relationship. The document on the document table 12 is exposed by the first scanning unit 23, and the light reflected from the document is lead to the image forming lens 25 by the first and second scanning units 23 and 24. The image on the document is formed on the CCD 26 by the image forming lens 25.

When the image or images on one side or both sides of the document is read in this way, the image data on one side or both sides of the document is inputted to the control section 7. The control section 7 has an image data processing section, and various image processings are performed for the image data by the image data processing section. Then, the image data is outputted to the image forming section 3.

The image forming section 3 prints a color image or a black-and-white image on a sheet on the basis of the inputted image data. The image forming section 3 is provided with a laser scanning unit 30, four image stations 31, an intermediate transfer belt unit 32, a fixing apparatus 33, and a feeding apparatus 34.

The image stations 31 form color images corresponding to black, cyan, magenta and yellow, respectively. Each of the image stations 31 is provided with a photoconductor drum 35, a developing apparatus 36, a charging apparatus 37, a cleaning apparatus 38 and a neutralization apparatus (not shown).

The photoconductor drum 35 is rotatingly driven in one direction; the cleaning apparatus 38 cleans toner remaining on the surface of the photoconductor drum 35; and the neutralization apparatus removes electrical charges on the surface of the photoconductor drum 35. The charging apparatus 37 causes the surface of the photoconductor drum 35 to be electrically charged in a uniform fashion.

The laser scanning unit 30 modulates a laser beam on the basis of image data inputted from the image reading section or the like, repeatedly scans the surface of the photoconductor drum 35 in the horizontal scanning direction with the laser beam to form an electrostatic latent image on the surface of the photoconductor drum 35. The developing apparatus 36 supplies toner to the surface of the photoconductor drum 35, develops the electrostatic latent image, and forms a toner image on the surface of the photoconductor drum 35.

The intermediate transfer belt unit 32 is provided with an intermediate transfer belt 40, intermediate transfer rollers 41, a transfer belt cleaning apparatus 42 and a tension mechanism 43. The intermediate transfer roller 41 is arranged above the photoconductor drum 35 and wound around a drive roller 44 and a driven roller 45, and it rotates in the direction of an arrow B.

The intermediate transfer roller 41 is disposed opposite to the photoconductor drum 35 by sandwiching the intermediate transfer belt 40, and is applied with a transfer bias voltage. By the voltage with a polarity reverse to that of the toner being applied by the intermediate transfer roller 41, the toner image on the surface of the photoconductor drum 35 is transferred to the intermediate transfer belt 40. The toner images of the respective colors are laminated on the intermediate transfer belt 40, and a synthesized, multicolored toner image is formed.

The intermediate transfer roller 41 is arranged being pressed to the intermediate transfer belt 40, and voltage with a polarity reverse to that of the toner is applied thereto. The toner image on the intermediate transfer belt 40 is transferred to a sheet fed between a transfer roller 46 and the intermediate transfer belt 40, by the transfer roller 46. The toner remaining on the intermediate transfer belt 40 is removed by the transfer belt cleaning apparatus 42.

The toner image transferred to the sheet is fixed on the sheet by being heated and pressurized by the fixing apparatus 33, and an image is formed on the sheet. The sheet on which the image is printed in this way is discharged to a discharge tray 50 provided at the upper part of the cabinet 1.

The feeding apparatus 34 feed a sheet from a sheet cassette 51 or a manual tray 52, along a paper path 53. The paper path 53 passes between the intermediate transfer belt 40 and the transfer roller 46, passes through the fixing apparatus 33, and reaches the discharge tray 50.

The feeding apparatus 34 is provided with pickup rollers 54, feeding rollers 55, a resist roller 56 and a discharge roller 57. Sheets in the sheet cassette 51 or the manual tray 52 are sent out to the paper path 53 one by one, fed along the paper path 53, and discharged to the discharge tray 50. While the sheets are being fed, an image is printed thereon. A switchback path 58 is also provided to enable both-side printing. The sheet for which fixation has been performed is caused to travel through the switchback path 58 by the feeding roller 55 and fed into between the intermediate transfer belt 40 and the transfer roller 46. The both-side printed sheet passes through the fixing apparatus 33 and is discharged to the discharge tray 50.

The operation panel 6 is provided for the scanner section 10, and it has an operating section 60 and a display section 61. The operating section 60 is provided with various operation keys. The display section 61 is configured by a liquid crystal display, and it is a touch panel. Touch keys are formed within an operation screen displayed on the display section 61, and these keys also function as operation keys.

The communication section 5 is provided with a communication interface, and the communication interface is connected to a network such as a LAN and a WAN. Multiple external apparatuses are connected to the network. The external apparatuses include other image processing apparatuses, information processing apparatuses such as a personal computer, and servers. The network is connected to the Internet from a router, via a communication line such as a telephone line and an optical fiber line. The communication section 5 can communicate with the external apparatuses via the network, with the use of a predetermined communication protocol. The image processing apparatuses can also communicate with one another. Communication within the network can be performed wiredly and wirelessly. An image processing system is formed by these image processing apparatuses and external apparatuses.

The communication section 5 is also provided with a modem apparatus. A telephone line is connected to the modem apparatus. The image processing apparatus can perform facsimile communication. The image processing apparatus is also capable of performing data communication by Internet facsimile via the network. Furthermore, the communication section 5 is provided with a communication terminal and a communication card for wireless communication. A storage medium such as a USB memory and an IC card is connected to the communication terminal, and the communication section 5 sends and receives data to and from the storage medium. The communication section 5 also sends and receives data to and from a communication terminal such as a mobile phone and a PDA via wireless communication, through the communication card.

The storage section 4 is configured by a hard disk apparatus. The storage section 4 stores image data inputted from the image reading section 2 or image data inputted from the communication section 5. The inputted image data is once stored in an image memory such as a DRAM, and it is transferred from the image memory to the storage section 4 after image processing or encryption processing is performed therefor. When the image data is read from the storage section 4, image processing or decryption processing is performed therefor, and then the image data is stored in the image memory. After that, the image data is outputted to the outside by printing, data transmission or facsimile communication in accordance with executed processing.

The storage section 4 has a management table 62. In the management table 62, information required for causing the image processing apparatus to operate is stored, such as control information and setting information about the image processing apparatus, and authentication information about a user. When such information is created or changed, the information in the management table 62 is updated. The management table 62 may be provided in a non-volatile memory different from the storage section 4.

The control section 7 is configured by a micro computer having a CPU, a ROM and a RAM. The CPU reads a control program stored in the ROM onto the RAM and executes the control program. Each section operates in accordance with the control program. When image data is inputted, any mode among the print mode, the copy mode, the scanner mode and the facsimile mode is executed on the basis of input information from the operating section 60 or processing conditions included in the header information of image data inputted from an external apparatus. The control program includes a browser and mail software, and the control section 7 performs data communication with external apparatuses, and sends and receives e-mails to and from the external apparatuses, with the use of communication protocols such as the TCP/IP protocols.

When executing each mode, the control section 7 temporarily stores inputted image data in the storage section 4. The control section 7 also executes a filing mode for storing inputted image data in the storage section 4 and managing the image data. The stored image data is re-outputted in accordance with instructed processing.

The outputted image data is erased from the storage section 4 in response to an instruction from the control section 7. When performing this erasure, the image data is invalidated so that it cannot be restored, by overwriting random data on the image data. By performing the invalidation processing and further performing encryption processing, unauthorized use of the image data is prevented.

In order to prevent a confidential document from being unauthorizedly copied or facsimile-transmitted, specific images are added to a document. The specific image indicates restraint information for performing restriction of processing to be executed, such as inhibition of copying, degradation of printing image quality, inhibition of data transmission and facsimile communication, and inhibition of filing.

The control section 7 generates image data with which specific images are synthesized, and performs processings such as printing, data transmission and filing of the synthesized image data. Image information about the specific images is stored in the management table 62 in advance. The image information includes the form, image forming conditions, position and the like of the specific images. The control section 7 reads the image information, and generates specific images, and synthesizes them with inputted image data on the basis of the image information.

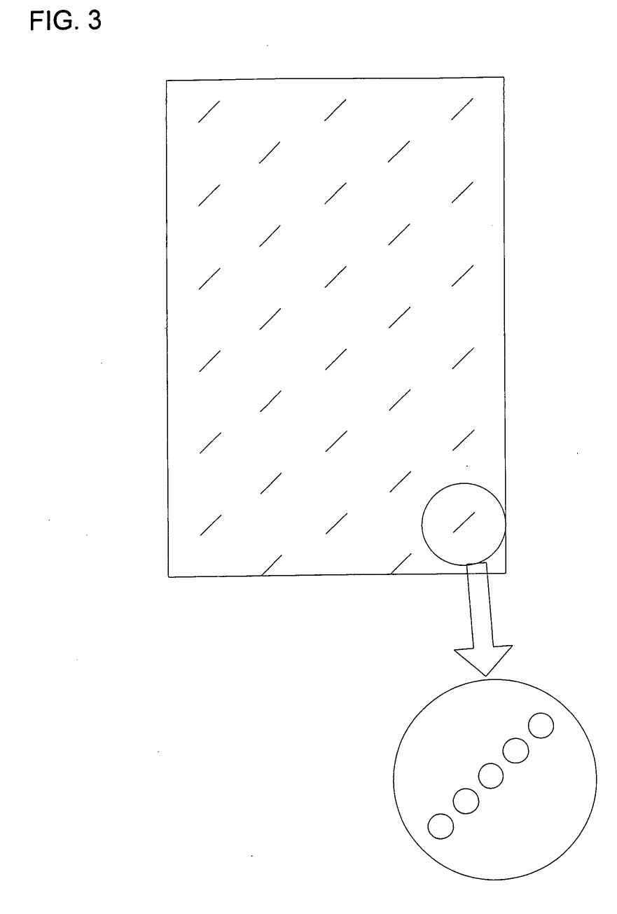

When the image data is printed, a document including the specific images as shown in FIG. 3 is created. The specific images are assumed to be formed in such a pattern that multiple images are linearly arranged in a predetermined direction. Specific images in the same form are uniformly arrayed in a predetermined direction and regularly arranged at predetermined positions. One document page includes multiple specific images. The image data including the specific images is transmitted via the communication section 5. When the image processing apparatus which has received this image data prints the image data, a document including the specific images is created.

It is difficult for a person to visually recognize a specific image in a document. However, the specific image can be read by the image reading section 2. There may be a case where similar images which are similar to specific images exist in a document, such as those of a background or a ground pattern. Such similar images are read by the image reading section 2.

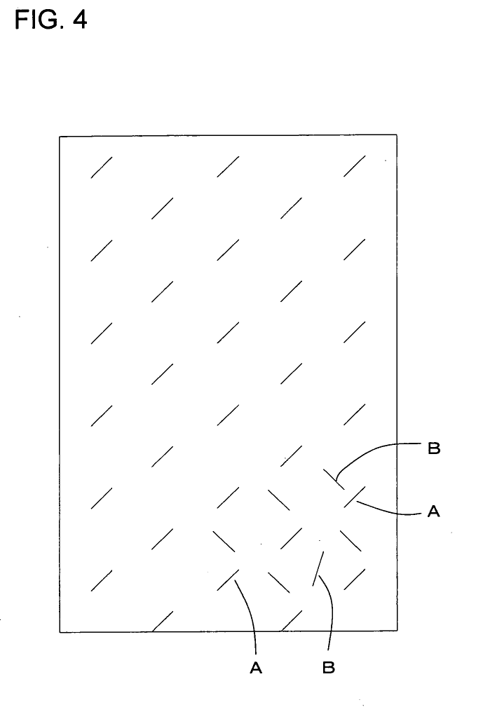

As shown in FIG. 4, the similar images are assumed to be formed in such a pattern that multiple images are linearly arranged in irregular directions. In the figure, “A” indicates a specific image, and “B” indicates a similar image. That is, the form of the similar images is the same as the form of the specific images. However, the specific images have a predetermined angle, while the similar images point in irregular directions with angles different from the angle of the specific image.

Accordingly, there are provided a specific image judgment section 63 for detecting whether specific images are included in inputted image data and judging whether or not the number of specific images exceeds a threshold, and a similar image identification section 64 for identifying similar images included in the image data. The image data is not limited to image data inputted from the image reading section 2. It may be inputted from an external apparatus through the communication section 5, or from a storage medium or a communication terminal.

The control section 7 restricts processing to be executed when the number of specific images exceeding a threshold is included in the inputted image data. That is, the control section 7 instructs inhibition of copying in the case of the copy mode, and instructs inhibition of transmission in the case of the facsimile mode or the scanner mode. In the case of the filing mode, the control section 7 instructs inhibition of storage of image data, to the storage section 4. Even if specific images are detected, the control section 7 does not restrict processing if the number of specific images does not exceed the threshold.

The operation of the specific image judgment section 63 is controlled by the control section 7, and it has functions as a detection section 70 for detecting specific images in image data and a judgment section 71 for judging whether or not the number of specific images exceeds a threshold.

The detection section 70 detects specific images by performing pattern matching between inputted image data and image data corresponding to specific images. The image data corresponding to specific images are recorded in advance and stored in the management table 62. The judgment section 71 counts the number of detected specific images and judges whether or not the number of detected specific images exceeds a threshold. When image data is created in pages, the number of specific images is calculated for each page. Alternatively, the number of specific images in a predetermined area size is calculated.

The operation of the similar image identification section 64 is controlled by the control section 7. The similar image identification section 64 has functions as an identification section 72 for, when similar images exist, identifying a target area in which the similar images exist and a threshold determination section 73 for determining a threshold on the basis of the target area.

The threshold determination section 73 stores a threshold set by an authorized user such as an administrator, in the management table 62. The authorized user is authenticated by inputting authentication information, for example, a password and biometric information such as a fingerprint. The authenticated user can set a threshold via the operating section 60. When similar images exist, the threshold determination section 73 changes the set threshold on the basis of a target area.

There is a possibility that similar images are recognized as specific images by mistake. For example, when a document is read to input image data, the document may be read being inclined. When similar images as described above exist, they become images pointing in a certain direction similarly to specific images. The detection section 70 can detect such similar images. In this case, if the similar images are detected as specific images, an accurate number of specific images cannot be obtained. Thus, the existence of similar images influences judgment of specific images.

If similar images exist, an area appears in which the array of specific images changes. This area is regarded as a target area. Accordingly, the identification section 72 identifies the target area within a predetermined range. The threshold determination section 73 determines a threshold on the basis of the size ratio of the target area to the predetermined range. When image data is created in pages, the predetermined range corresponds to one page.

As described above, the specific image judgment section 63 detects similar images in inputted image data. When similar images are detected, the similar image identification section 64 identifies a target area in which the similar images exist and changes the threshold so that the existence of the similar images does not influence judgment of specific images for executing restriction of processing. Thereby, it is possible to make judgment excluding the influence of the similar images.

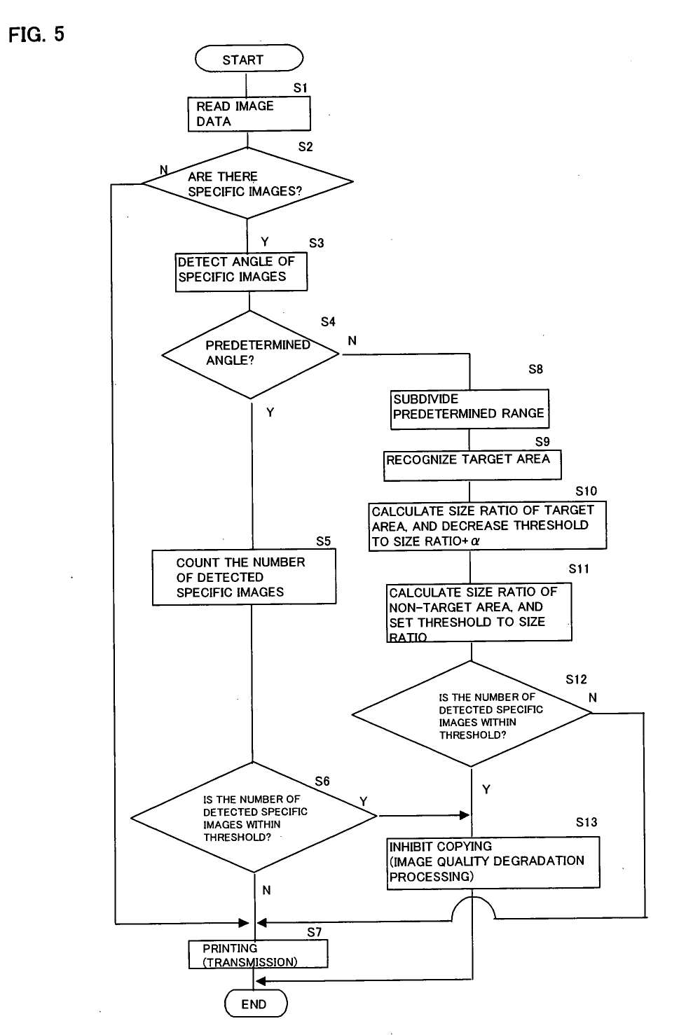

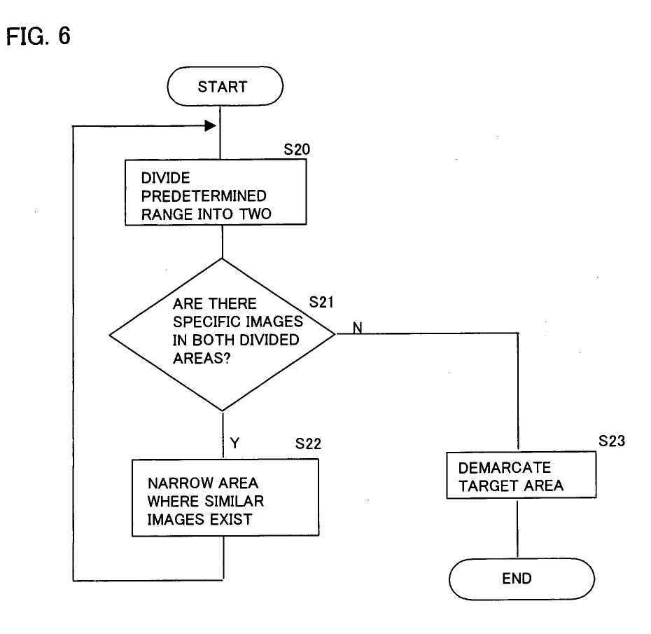

Description will be made on the procedures for executing processing on the basis of the detection of specific images and similar images described above, with reference to FIGS. 5 and 6. Here, a document is read, and the image data is inputted. First, a user sets a document in the image reading section 2 and operates the operation keys on the operation panel 6. The document is read, and the image data is inputted (S1). The detection section 70 of the specific image judgment section 63 detects specific images from the image data inputted from the image reading section 2 (S2). If specific images are not detected, instructed processing such as printing and data transmission is executed (S7).

When specific images are detected, the detection section 70 checks whether similar images are included. That is, the angles of the detected specific images are checked (S3). When only specific images having a predetermined angle are detected (S4), similar images do not exist. In this case, the judgment section 71 counts the number of detected specific images (S5) and judges whether or not the number of specific images exceeds a threshold (S6).

When the threshold is not exceeded, instructed processing such as printing and data transmission is executed (S7). When the threshold is exceeded, the processing is restricted (S13). In accordance with the instructed processing, for example, copying is inhibited. There may be a case where the processing for degrading the image quality is performed though copying is performed, in accordance with the restraint information indicated by the specific images.

When similar images having an angle different from the angle of the specific images, the identification section 72 identifies a target area. That is, one page, which is a predetermined range, is subdivided into multiple areas (S8). When the subdivision is performed, the page is equally divided, and the sizes of the respective areas are the same.

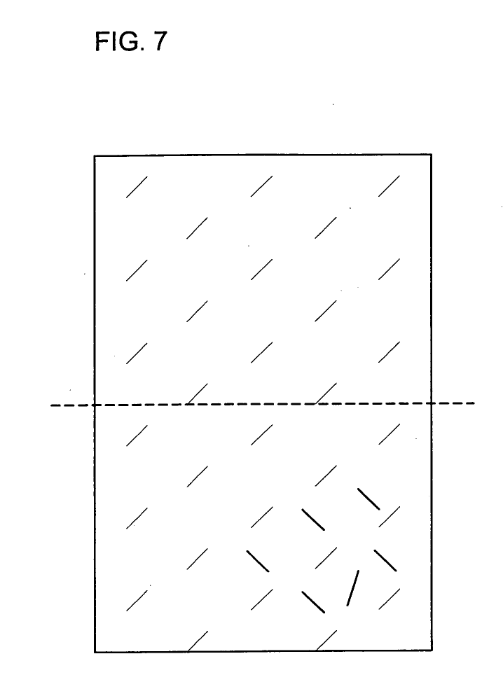

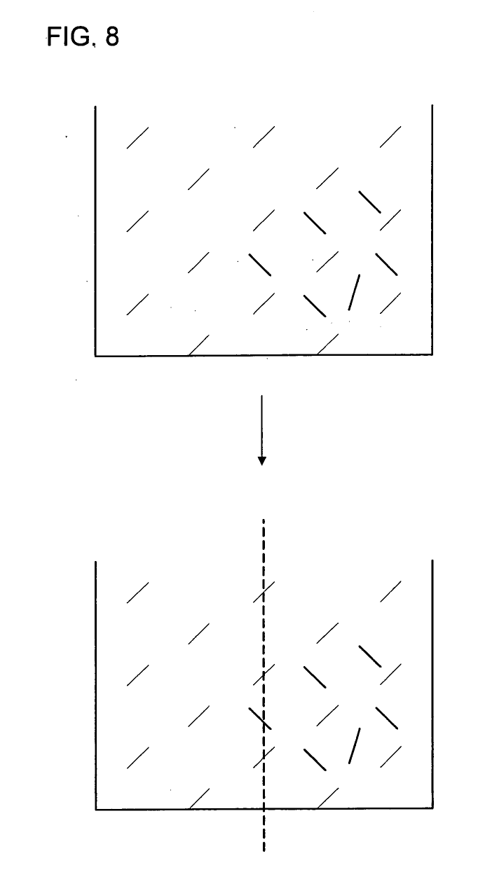

First, one page is divided into two as shown in FIG. 7 (S20). In this case, the similar images exist in the lower-side area as shown in FIG. 8. Next, the lower-side area is divided into two.

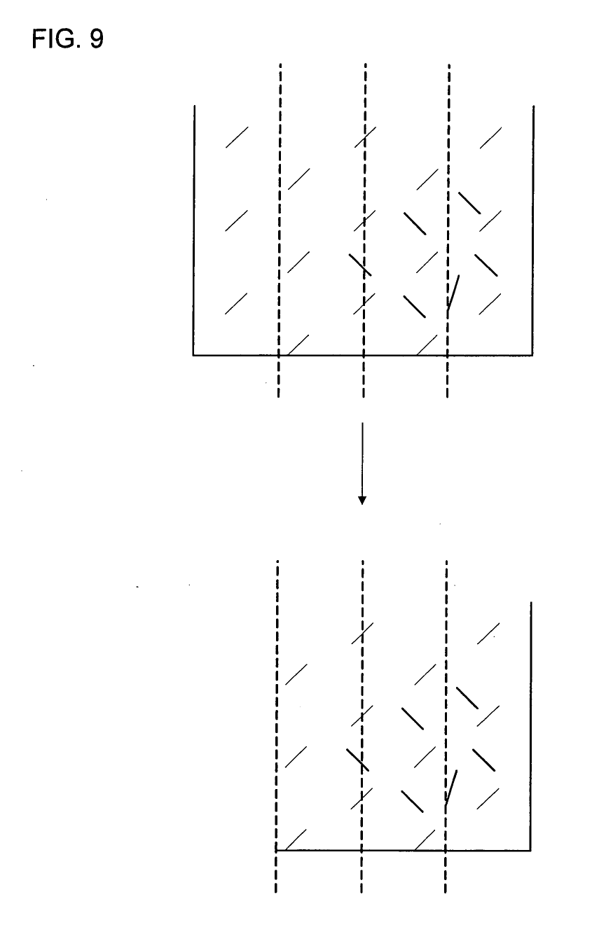

If the similar images exist in both of the halved areas (S21), the identification section 72 equally divides the lower-side area into multiple areas as shown in FIG. 9. Then, if there is an area having no similar image, the area is excluded. For example, the lower-side area is divided into four. In this case, there is no similar image in the left-end area, this area is excluded. The areas where the similar images exist are limited, and three areas are left (S22).

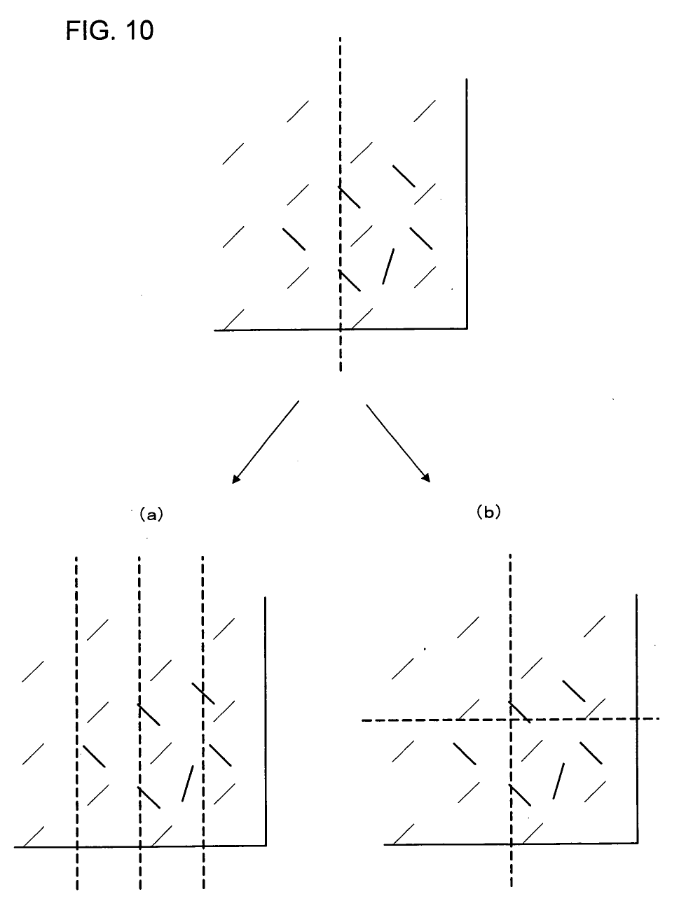

As shown in FIG. 10, the identification section 72 divides the whole of the remaining areas into two again (S21). If the similar images exist in both of the two divided areas (S21), the whole of the areas is equally divided into multiple areas again (S22). FIG. 10(a) shows that the whole of the areas is divided into four vertically, and FIG. 10(b) shows that the whole of the areas is divided into four horizontally and vertically. In FIG. 10(a), there is no similar image in the left-end area. In FIG. 10(b), there is no similar image in the upper-left area.

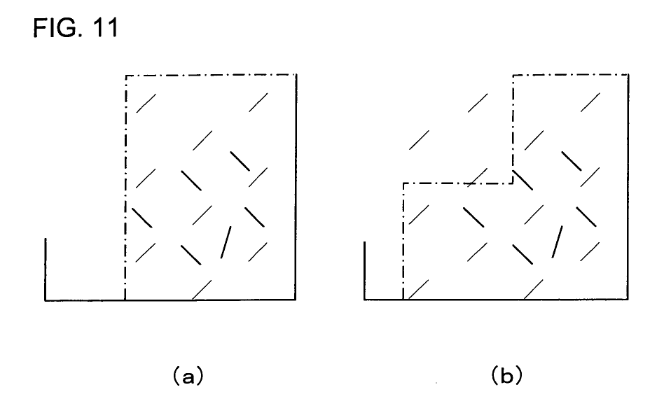

Finally, only the areas where the similar images exist are left, and a target area is demarcated by the remaining areas (S23). In FIG. 11(a), there is formed a long and narrow target area constituted by the subdivided three areas. Similarly, in FIG. 11(b), there is formed an inverted L shaped target area. In the one page, the area other than the target area is a non-target area where there is no similar image.

If the similar images exist only one of the halved areas (S21), the identification section 72 does not perform subdivision any more. The one area is demarcated as a target area (S23).

The threshold determination section 73 recognizes the identified target area (S9) and calculates the size ratio of the target area to the one page. Then, by adding a to a threshold based on the size ratio, a threshold is determined (S10). Furthermore, a threshold is determined in accordance with a size ratio of the non-target area (S11).

That is, the threshold for the target area is set larger than the threshold determined on the basis of the size ratio of the target area to the predetermined range, and, as the threshold for the non-target area, the threshold determined on the basis of the size ratio of the non-target area to the predetermined range is set. Specifically, the threshold for the target area is indicated by Sa/S×N+α, and the threshold for the non-target area is indicated by Sb/S×N, wherein the size of one page is denoted by S, the size of the target area is denoted by Sa, the size of the non-target area is denoted by Sb, and the threshold is denoted by N, and α is a predetermined constant. However, α may be the number determined on the basis of the size ratio of the target area.

The judgment section 71 counts not only the number of specific images in the target area but also the number of specific images in the non-target area. When the number of specific images exceeds the changed threshold in at least one of the target and non-target areas, processing is restricted (S12). If the threshold is exceeded in neither of the areas, the instructed processing is executed (S7).

As described above, when similar images exist in image data, the area where the similar images exist is identified, the number is counted including the similar images which are difficult to distinguish from specific images, and it is judged whether a threshold is exceeded. By counting the number regarding the similar images as specific images, and increasing the threshold for the target area, it is possible to detect all the specific images without fail though the number of counted specific images increases. Thereby, it is possible to eliminate the influence of the similar images, judge that specific images are included without fail, and certainly restrict processing.

As another embodiment of identifying a target area, the target area is identified on the basis of position information about similar images. When detecting similar images, the detection section 70 extracts position information about the similar images from image data. The identification section 72 identifies a target area on the basis of the position information. The threshold determination section 73 determines a threshold for the target area and a threshold for the non-target area. The judgment section 71 judges whether specific images are included on the basis of the determined thresholds.

Here, the coordinates of the similar images are used as the position information. When image data is developed on one page, the vertical direction and the horizontal direction are assumed to be a Y direction and an X direction, respectively. The identification section 72 demarcates the perimeter of the target area, from the X coordinates and Y coordinates of the multiple similar images.

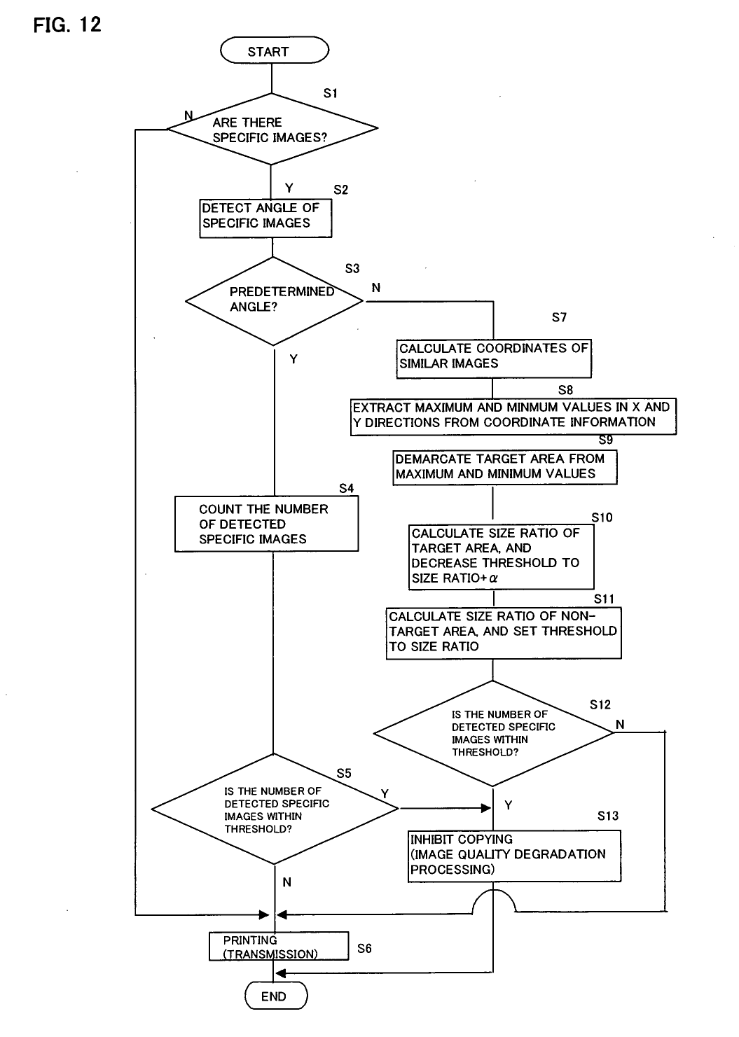

The procedure for identifying the target area is shown in FIG. 12. When image data is inputted, the detection section 70 detects specific images from the image data (S1). When the specific images are detected, the detection section 70 checks the angles of the specific images (S2). When only specific images having a predetermined angle are detected (S3), the judgment section 71 counts the number of detected specific images (S4), and judges whether or not the number of specific images exceeds a threshold (S5).

When the threshold is not exceeded, instructed processing such as printing and data transmission is executed (S6). When the threshold is exceeded, the processing is restricted (S13). In accordance with the instructed processing, for example, copying is inhibited. There may be a case where the processing for degrading the image quality is performed though copying is performed, in accordance with the restraint information indicated by the specific images.

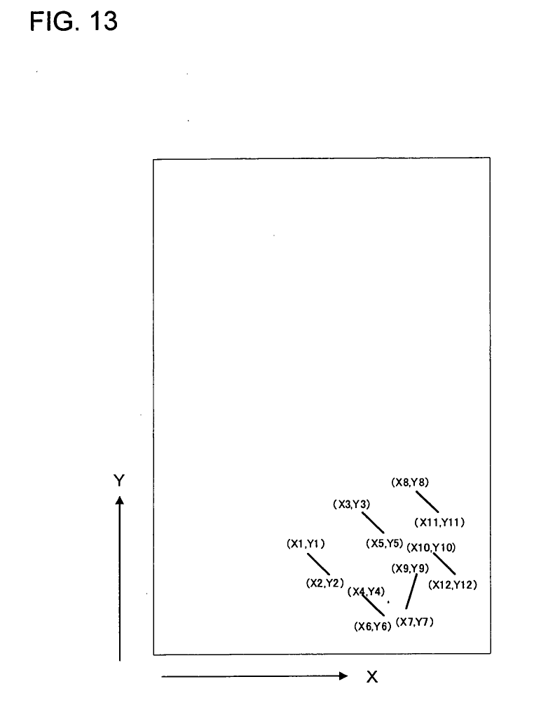

When similar images having an angle different from the angle of the specific images are detected, the identification section 72 identifies a target area. That is, the coordinates of the similar images are calculated (S7). As shown in FIG. 13, the coordinates of the apexes of the multiple similar images are calculated. Then, the identification section 72 extracts the maximum and minimum values of the X and Y coordinates (S8). Here, the minimum value of the X coordinates, the maximum value of the X coordinates, the minimum value of the Y coordinates and the maximum value of the Y coordinates are X1, X12, Y6 and Y8, respectively.

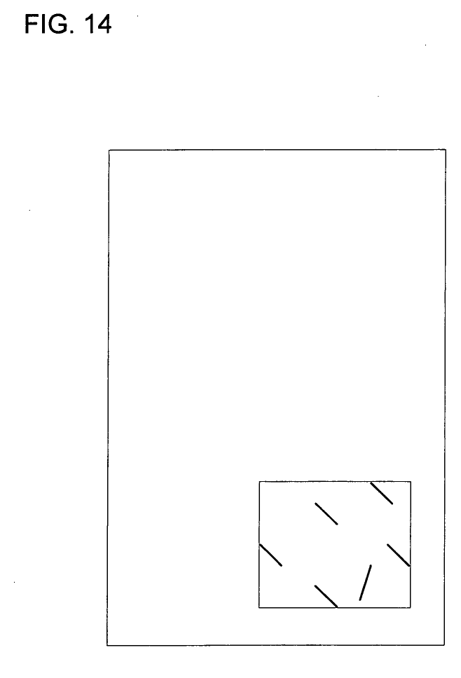

The identification section 72 demarcates the perimeter of a target area on the basis of the coordinates of the maximum values and the minimum values (S9). That is, the coordinates of similar images existing on the outer edge are identified, and a rectangular area surrounded by lines passing through the coordinates of the maximum values and the minimum values is formed as shown in FIG. 14. In this way, the perimeter of the rectangular area is demarcated. The identification section 72 sets this area as the target area. The procedures at and after S10 are the same as the procedures at and after S10 shown in FIG. 5. The threshold for each of the target area and the non-target area is determined, and judgment is performed.

By identifying the target area on the basis of the position information about the similar images, an area in which the similar images exist can be limited. Therefore, when judgment of specific images is performed, the influence of the similar images can be eliminated, and accurate judgment can be performed.

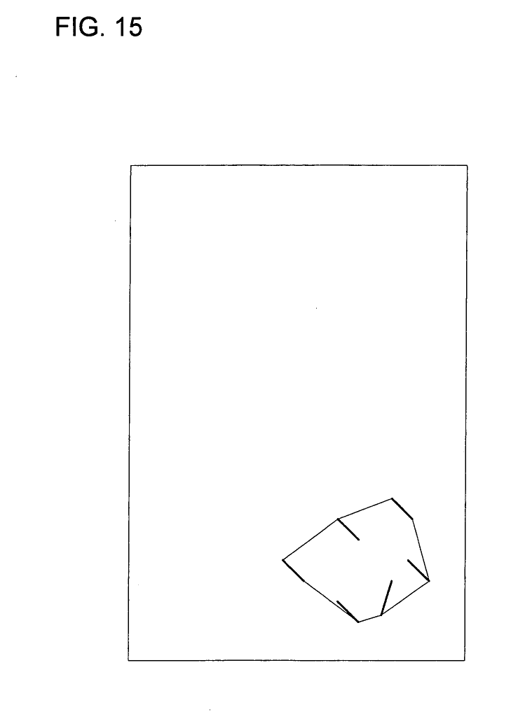

Instead of identifying the target area on the basis of the maximum and minimum values of the coordinates of the similar images as described above, the target area is identified on the basis of the apexes of the outer edge side of the similar images. The identification section 72 extracts multiple similar images existing on the outer edge and identifies the apexes on the outer edge side. As shown in FIG. 15, by connecting the multiple apexes, a surrounded area is formed, and the perimeter of this area is demarcated. The identification section 72 sets this area as the target area.

As described above, by utilizing position information about similar images, a target area can be limited in accordance with the distribution of the similar images. Thereby, it is possible to limit the range influenced by the similar images, make judgment of specific images so that the judgment is not influenced by the similar images, and cause the function of the specific images to be sufficiently exhibited.

The identification of a target area described above is preferable when multiple similar images exist in a cluster. When similar images are scattered, it is difficult to identify a target area. In such a case, the threshold determination section 73 changes the threshold for the whole predetermined range in order that the influence of the similar images is eliminated to make judgment of specific images. That is, the threshold for one page is decreased.

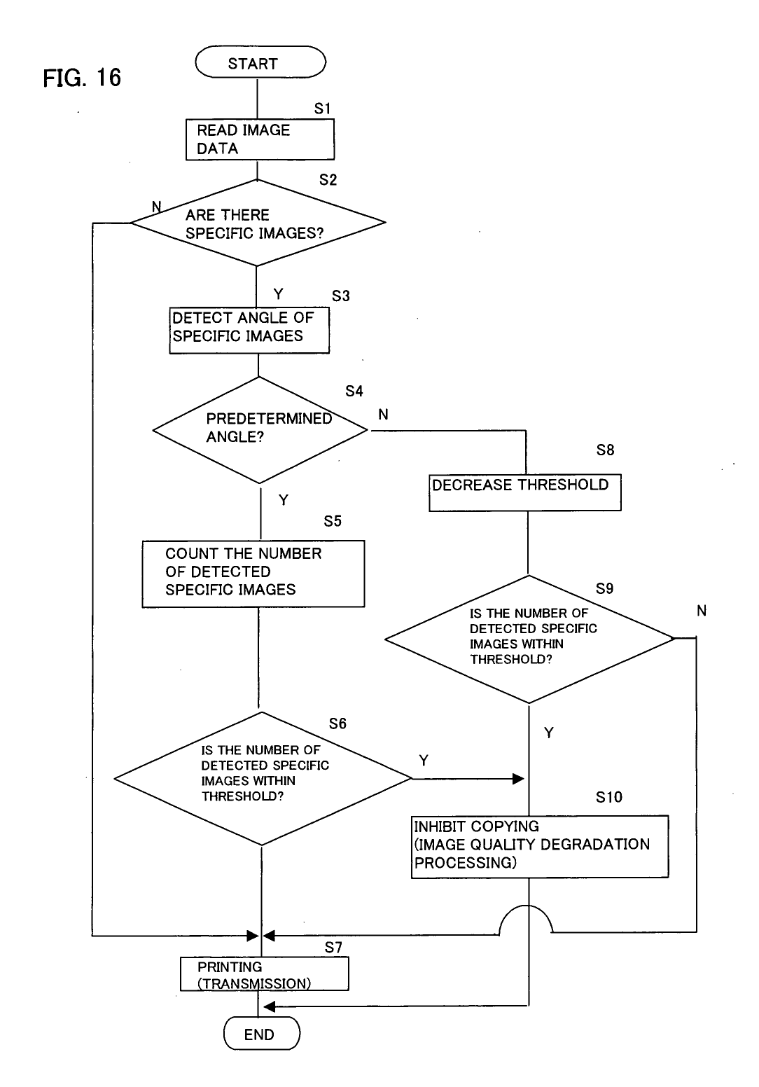

FIG. 16 shows the procedure for changing a threshold. When a document is set in the image reading section 2 and read, and the image data is inputted (S1). The detection section 70 detects specific images from the image data (S2). When the specific images are detected, the detection section 70 checks the angles of the specific images (S3). When only specific images having a predetermined angle are detected (S4), the judgment section 71 counts the number of detected specific images (S5), and judges whether or not the number of specific images exceeds a threshold (S6).

When the threshold is not exceeded, instructed processing such as printing and data transmission is executed (S7). When the threshold is exceeded, restriction of the processing such as inhibition of copying is performed (S10).

When similar images having an angle different from the angle of the specific images are detected, the identification section 72 judges whether the similar images exist in a cluster or they are scattered. Specifically, the identification section 72 equally divides one page, which is a predetermined range, into multiple areas and checks whether there is a similar image in each area. When the number of areas having a similar image is smaller than a predetermined number, it is judged that the similar images exist in a cluster. In this case, the target area is identified as described above.

When the number of areas having a similar image is the predetermined number or larger, the identification section 72 judges that the similar images are scattered. In this case, the threshold determination section 73 decreases the threshold (S8). Here, the number by which the threshold is decreased is a predetermined constant number. The image data is processed in pages. Therefore, when the threshold is determined according to page sizes, it is desirable to determine the number by which the threshold is decreased on the basis of the page size and set a larger number as the number by which the threshold as the page size is larger.

Then, the judgment section 71 counts the number of specific images and judges whether or not the number of specific images exceeds the changed threshold (S9). When the number of specific images exceeds the threshold, processing is restricted (S10). When the threshold is not exceeded, the instructed processing is executed (S7).

As described above, when similar images exist in image data, being scattered, it is difficult to distinguish between specific images and the similar images. In this case, only the number of such specific images as can be certainly distinguished is counted, without counting the number of such specific images as are difficult to distinguish, to judge whether the threshold is exceeded. Since the similar images which are difficult to distinguish are not counted, it is possible to accurately detect only specific images. Though the number of counted specific images decreases, it is possible to correctly make judgment of specific images and certainly restrict processing because the changed threshold has been decreased.

As another embodiment of judging specific images, a target area in which similar images exit is excluded from the target of judgment. That is, when the target area is identified by the identification section 72, the judgment section 71 counts the number of specific images. In this case, specific images in a non-target area are counted. As for the target area, the counting is not performed even if specific images exist in the target area. The threshold determination section 73 decreases the threshold on the basis of the size ratio of the non-target area to a predetermined range.

Thus, by excluding a target area in which similar images exist, when performing judgment of specific images, it is possible to completely eliminate the influence of the similar images and prevent misjudgment due to the similar images.

The present invention is not limited to the above embodiments, and, of course, a lot of modifications and changes can be made in the above embodiments within the range of the present invention. The form of specific images is not limited to the form in which they point in a certain direction. A form having irregular pattern, character images, such as “Copy inhibited” and “Strictly restricted”, and a form of the combination of characters and patterns are also possible. When a specific image is a character image, the possibility that similar images may exist is low. However, there is a possibility that a malicious user modifies the specific images to make them look like similar images. In such a case, it is useful to eliminate the influence of similar images to make judgment of specific images.

What is claimed is:

1. An image processing apparatus comprising:
a detection section for detecting specific images in image data;
a judgment section for judging whether or not the specific images are included in the image data on the basis of a threshold; and
an identification section for, when similar images in a form similar to the form of the specific images exist, identifying the similar images; wherein
the judgment section eliminates the influence of the identified similar images to make judgment.

2. The image processing apparatus according to claim 1, further comprising a threshold determination section for determining the threshold, wherein
the identification section identifies a target area in which the similar images exist; and
the threshold determination section changes the threshold on the basis of the target area.

3. The image processing apparatus according to claim 1, wherein
the identification section identifies a target area in which the similar images exist; and
the judgment section excludes the target area when performing judgment.

4. The image processing apparatus according to claim 2, wherein
the detection section detects similar images within a predetermined range; and
the identification section subdivides the predetermined range to identify the target area.

5. The image processing apparatus according to claim 3, wherein
the detection section detects similar images within a predetermined range; and
the identification section subdivides the predetermined range to identify the target area.

6. The image processing apparatus according to claim 4, wherein
the identification section judges whether there is a similar image or not in each of areas obtained by subdividing the predetermined range, and excludes areas having no similar image to identify the target area.

7. The image processing apparatus according to claim 5, wherein
the identification section judges whether there is a similar image or not in each of areas obtained by subdividing the predetermined range, and excludes areas having no similar image to identify the target area.

8. The image processing apparatus according to claim 4, wherein
the threshold determination section determines the threshold on the basis of the size ratio of the target area to the predetermined range.

9. The image processing apparatus according to claim 5, wherein
the threshold determination section determines the threshold on the basis of the size ratio of the target area to the predetermined range.

10. The image processing apparatus according to claim 2, wherein
the detection section detects position information about similar images within a predetermined range; and
the identification section identifies the target area on the basis of the position information.

11. The image processing apparatus according to claim 3, wherein
the detection section detects position information about similar images within a predetermined range; and
the identification section identifies the target area on the basis of the position information.

12. The image processing apparatus according to claim 10, wherein
the identification section identifies the similar images existing on the outer edge, from the position information about the multiple similar images and demarcates the perimeter of the target area.

13. The image processing apparatus according to claim 11, wherein
the identification section identifies the similar images existing on the outer edge, from the position information about the multiple similar images and demarcates the perimeter of the target area.

14. The image processing apparatus according to claim 10, wherein
the threshold determination section determines the threshold on the basis of the size ratio of the target area to the predetermined range.

15. The image processing apparatus according to claim 11, wherein the threshold determination section determines the threshold on the basis of the size ratio of the target area to the predetermined range.
